(19) United States
(12) Patent Application Publication
(10) Pub. No.: US 2025/0181991 A1
(43) Pub. Date: Jun. 5, 2025

(54) FEATURE DIMENSIONALITY REDUCTION FOR MACHINE LEARNING MODELS

(71) Applicant: International Business Machines Corporation, Armonk, NY (US)

(72) Inventors: Lukasz G. Cmielowski, Kraków (PL); Daniel Jakub Ryszka, Kraków (PL); Rafal Maciasz, Porabka Iwkowska (PL); Nikodem Szwast, Kraków (PL)

(21) Appl. No.: 18/525,829

(22) Filed: Nov. 30, 2023

(51) Int. Cl. G06N 20/20

(52) U.S. Cl. CPC G06N 20/20

(57) ABSTRACT

Provided is a method, system, and computer program product for performing automated feature dimensionality reduction without accuracy loss. A processor may determine a first training value associated with a first dataset of a machine learning model. The processor may rank features of the first dataset in relation to the first training value. The processor may compare the ranked features of the first dataset to a predetermined threshold. The processor may generate a second dataset from the first dataset by removing a third dataset, the third dataset having a set of features that did not meet the predetermined threshold. The processor may determine a second training value associated with the second dataset. The processor may compare the first training value to the second training value. In response to the second training value being lower than the first training value, the processor may analyze the third dataset with a dimensionality reduction algorithm.

### BACKGROUND

The present disclosure relates generally to machine learning models, particularly focusing on the implementation of automated feature dimensionality reduction techniques on training datasets. These techniques aim to reduce the number of features while ensuring that the machine learning model's accuracy remains unaffected.

AutoML (Automated Machine Learning) and AutoAI (Automated Artificial Intelligence) are innovative technologies designed to automate and streamline the process of creating machine learning and artificial intelligence models, making these sophisticated techniques more accessible to a broader range of users.

Traditionally, building machine learning models requires in-depth expertise, involving tasks like feature selection, hyperparameter tuning, model selection, and data preprocessing. AutoML emerged to automate these complex processes, enabling non-experts to leverage machine learning algorithms more easily. The concept of AutoML gained traction in the early 21st century, with researchers and data scientists aiming to automate various stages of the machine learning pipeline. The goal was to reduce the burden of manual tuning and configuration, while improving the efficiency and accuracy of models. Over the years, several companies, open-source initiatives, and research institutions developed AutoML platforms, frameworks, and tools to democratize machine learning. These platforms often incorporate techniques like hyperparameter optimization, feature engineering, and model selection in an automated fashion.

AutoAI extends the concept of automation to a broader spectrum of artificial intelligence techniques beyond traditional machine learning, encompassing natural language processing (NLP), computer vision, and other AI domains. Many AutoAI platforms and tools are designed to cater to businesses seeking to integrate AI solutions without extensive technical knowledge. These platforms often prioritize ease of use and quick deployment of AI models for specific business needs.

Often, there's a trade-off between the accuracy of automated models and their interpretability. While AutoML and AutoAI automate many tasks, expert intervention is sometimes necessary for fine-tuning or adjusting models based on specific requirements or domain expertise.

### SUMMARY

Embodiments of the present disclosure include a method, system, and computer program product for performing automated feature dimensionality reduction techniques on training datasets of the machine learning model. A processor may determine a first training value associated with a first dataset of a machine learning model. The processor may rank features of the first dataset in relation to the first training value. The processor may compare the ranked features of the first dataset to a predetermined threshold. The processor may generate a second dataset from the first dataset by removing a third dataset, the third dataset having a set of features that did not meet the predetermined threshold. The processor may determine a second training value associated with the second dataset of the machine learning model. The processor may compare the first training value associated with the first dataset to the second training value associated with the second dataset of the machine learning model. In response to the second training value being lower than the first training value, the processor may analyze the third dataset with a dimensionality reduction algorithm.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example automated machine learning system, in accordance with embodiments of the present disclosure.

FIG. 2A and FIG. 2B illustrate a flow diagram of an example process for automated feature dimensionality reduction for machine learning model training, in accordance with some embodiments of the present disclosure.

FIG. 3 illustrates an example results comparison, in accordance with some embodiments of the present disclosure.

FIG. 4 illustrates a high-level block diagram of an example computer system that may be used in implementing one or more of the methods, tools, and modules, and any related functions, described herein, in accordance with embodiments of the present disclosure.

FIG. 5 depicts a schematic diagram of a computing environment for executing program code related to the methods disclosed herein and for adaptive large language model training according to at least one embodiment.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to machine learning models and, more particularly, to performing automated feature dimensionality reduction techniques that produce robust machine learning models without accuracy loss. While the present disclosure is not necessarily limited to such applications, various aspects of the disclosure may be appreciated through a discussion of various examples using this context.

According to an aspect of the invention, there is provided a method comprising determining a first training value associated with a first dataset of a machine learning model, ranking features of the first dataset in relation to the first training value, comparing the ranked features of the first dataset to a predetermined threshold, generating a second dataset from the first dataset by removing a third dataset, the third dataset comprising a set of features that did not meet the predetermined threshold, determining a second training value associated with the second dataset of the machine learning model, comparing the first training value associated with the first dataset to the second training value associated with the second dataset of the machine learning model, and in response to the second training value being lower than the first training value, analyzing the third dataset with a dimensionality reduction algorithm. This approach for insignificant feature analysis is advantageous because adoption of the training values (e.g., cross-validation score) may be used to determine if estimated feature importance impacts model performance and/or accuracy.

In embodiments, the method may further comprise generating, based on the analyzing, a transformed dataset from the third dataset, wherein the transformed dataset comprises one or more significant features that were generated from the set of features that did not meet the predetermined threshold. This is advantageous because when the second training value of the second dataset (e.g., reduced dataset) is lower than the first training value of the first dataset (e.g., whole dataset), the method may transform insignificant features that were rejected by a feature selector with features transformed using the best principal components computed for those features.

In embodiments, the method may further comprise merging the transformed dataset with the second dataset to generate a fourth dataset and determining a third training value associated with the fourth dataset of the machine learning model. This is advantageous over traditional training methods, because adding insignificant features that are transformed by the dimensionality reduction algorithm to create the transformed dataset can boost the training value of the second dataset (e.g., reduced dataset) when they are merged together.

In embodiments, the method may further comprise comparing the first training value associated with the first dataset to the third training value associated with the fourth dataset, and in response to the third training value exceeding the first training value, deploying the fourth dataset to a next stage for training the machine learning model. This is advantageous because using a reduced dataset that has no loss in accuracy when compared to the whole dataset can also speed up the process of training machine learning model within the machine learning pipeline.

In some embodiments, the method may further comprise comparing the first training value associated with the first dataset to the third training value associated with the fourth dataset of the machine learning model, and in response to the third training value being lower than the first training value, reverting to deployment of the first dataset to a next stage for training the machine learning model. This is advantageous because the method will identify accuracy loss associated with the fourth dataset (e.g., merged reduced dataset and the transformed dataset) has and will automatically revert back to the first dataset for moving to the next stage of the machine learning pipeline.

In some embodiments, each training value is based on a parameter associated with each dataset, and wherein the parameter is a feature importance value. In some embodiments, the ranking is performed by a random forest algorithm that estimates a significance of each feature. In some embodiments, the dimensionality reduction algorithm is a principal component analysis algorithm. In some embodiments, each training score is a cross-validation score used to determine an estimated feature importance related to performance of the machine learning model.

According to an aspect of the invention, there is provided a system comprising a processor and a computer-readable storage medium communicatively coupled to the processor and storing program instructions which, when executed by the processor, cause the processor to perform a method. The method performed by the processor comprises: determining a first training value associated with a first dataset of a machine learning model, ranking features of the first dataset in relation to the first training value, comparing the ranked features of the first dataset to a predetermined threshold, generating a second dataset from the first dataset by removing a third dataset, the third dataset comprising a set of features that did not meet the predetermined threshold, determining a second training value associated with the second dataset of the machine learning model, comparing the first training value associated with the first dataset to the second training value associated with the second dataset of the machine learning model, and in response to the second training value being lower than the first training value, analyzing the third dataset with a dimensionality reduction algorithm. This approach for insignificant feature analysis is advantageous because adoption of the training values (e.g., cross-validation score) may be used to determine if estimated feature importance impacts model performance and/or accuracy.

In embodiments, the method performed by the processor of the system may further comprise generating, based on the analyzing, a transformed dataset from the third dataset, wherein the transformed dataset comprises one or more significant features that were generated from the set of features that did not meet the predetermined threshold. This is advantageous because when the second training value of the second dataset (e.g., reduced dataset) is lower than the first training value of the first dataset (e.g., whole dataset), the system may transform insignificant features that were rejected by a feature selector with features transformed using the best principal components computed for those features.

In embodiments, the method performed by the processor of the system may further comprise merging the transformed dataset with the second dataset to generate a fourth dataset and determining a third training value associated with the fourth dataset of the machine learning model. This is advantageous over traditional training systems, because adding insignificant features that are transformed by the dimensionality reduction algorithm to create the transformed dataset can boost the training value of the second dataset (e.g., reduced dataset) when they are merged together.

In embodiments, the method performed by the processor of the system may further comprise comparing the first training value associated with the first dataset to the third training value associated with the fourth dataset, and in response to the third training value exceeding the first training value, deploying the fourth dataset to a next stage for training the machine learning model. This is advantageous because using a reduced dataset that has no loss in accuracy when compared to the whole dataset can also speed up the process of training machine learning model within the machine learning pipeline.

In some embodiments, the method performed by the processor of the system may further comprise comparing the first training value associated with the first dataset to the third training value associated with the fourth dataset of the machine learning model, and in response to the third training value being lower than the first training value, reverting to deployment of the first dataset to a next stage for training the machine learning model. This is advantageous because the system will take into account when the fourth dataset (e.g., merged reduced dataset and the transformed dataset) experiences accuracy loss and will automatically revert back to the first dataset for moving to the next stage of the machine learning pipeline.

According to an aspect of the invention, there is provided a computer program product comprising a computer-readable storage medium having program instructions embodied therewith, the program instructions executable by a processor to cause the processor to perform a method. The method performed by the processor may comprise: determining a first training value associated with a first dataset of a machine learning model, ranking features of the first dataset in relation to the first training value, comparing the ranked features of the first dataset to a predetermined threshold, generating a second dataset from the first dataset by removing a third dataset, the third dataset comprising a set of features that did not meet the predetermined threshold, determining a second training value associated with the second dataset of the machine learning model, comparing the first training value associated with the first dataset to the second training value associated with the second dataset of the machine learning model, and in response to the second training value being lower than the first training value, analyzing the third dataset with a dimensionality reduction algorithm. This approach for insignificant feature analysis is advantageous because adoption of the training values (e.g., cross-validation score) may be used to determine if estimated feature importance impacts model performance and/or accuracy.

In embodiments, the method performed by the processor may further comprise generating, based on the analyzing, a transformed dataset from the third dataset, wherein the transformed dataset comprises one or more significant features that were generated from the set of features that did not meet the predetermined threshold. This is advantageous because when the second training value of the second dataset (e.g., reduced dataset) is lower than the first training value of the first dataset (e.g., whole dataset), the instructions of the computer program product may transform insignificant features that were rejected by a feature selector with features transformed using the best principal components computed for those features.

In embodiments, the method performed by the processor may further comprise merging the transformed dataset with the second dataset to generate a fourth dataset and determining a third training value associated with the fourth dataset of the machine learning model. This is advantageous over traditional training methods, because adding insignificant features that are transformed by the dimensionality reduction algorithm to create the transformed dataset can boost the training value of the second dataset (e.g., reduced dataset) when they are merged together.

In embodiments, the method performed by the processor may further comprise comparing the first training value associated with the first dataset to the third training value associated with the fourth dataset, and in response to the third training value exceeding the first training value, deploying the fourth dataset to a next stage for training the machine learning model. This is advantageous because using a reduced dataset that has no loss in accuracy when compared to the whole dataset can also speed up the process of training machine learning model within the machine learning pipeline.

In some embodiments, the method performed by the processor may further comprise comparing the first training value associated with the first dataset to the third training value associated with the fourth dataset of the machine learning model, and in response to the third training value being lower than the first training value, reverting to deployment of the first dataset to a next stage for training the machine learning model. This is advantageous because the computer program product will take into account when the fourth dataset (e.g., merged reduced dataset and the transformed dataset) has accuracy loss and will automatically revert back to the first dataset for moving to the next stage of the machine learning pipeline.

It is noted that data used in Auto ML systems for training models can be large. This fact causes that the training process lasts a long time. In most cases a few features included in dataset are insignificant for the model because they do not improve model performance. In this case data scientist reviews features and makes decision about removing a feature only when it is 100% sure the column is “insignificant”. The present disclosure addresses how to insert a functionality that is configured to optimise a dimensionality of a dataset into Automated AI building systems to decrease training process duration without making a models' quality worse. Embodiments of the present disclosure allow automated AI building system (AutoAI/AutoML) should be robust enough to speed up training process by reducing features number without accuracy loss, where the focus is on classification & regression models building tools.

In embodiments, a dimensionality reduction algorithm is employed to analyze features that have been rejected by the feature selector. This approach minimizes resource consumption compared to merely discarding these features while maintaining the pipeline's overall score, even if the computed feature importance for the Random Forest algorithm might not accurately represent each feature's true value for the model. During the feature engineering stage, a specific set of columns is generated based on a determined pathway, involving particular transformations applied to each feature. Consequently, there's a likelihood of creating insignificant features. To address this, a delta threshold can be specified to determine if a score drop is acceptable. For instance, if there's a minor score decrease, yet a significant proportion (e.g., 90%) of features can be discarded, the PCA stage might be considered worthwhile.

By incorporating insignificant features transformed through PCA, the model's score can potentially improve. This enhancement is particularly relevant when using an estimator that lacks a feature importance attribute, as features deemed insignificant by the Random Forest estimator might hold value for the system's employed estimator.

The primary advantage of these novel features is their ability to safeguard an automated machine learning system against decreases in accuracy scores (model performance), which are undesirable when striving for the best possible model. To mitigate such instances, score comparisons can be conducted. In cases of score reduction, the PCA algorithm can be utilized to diminish the dimensionality of the remaining features. This approach streamlines the entire model training process without compromising performance or effectiveness.

The aforementioned advantages are example advantages, and not all advantages are discussed. Furthermore, embodiments of the present disclosure can exist that contain all, some, or none of the aforementioned advantages while remaining within the spirit and scope of the present disclosure.

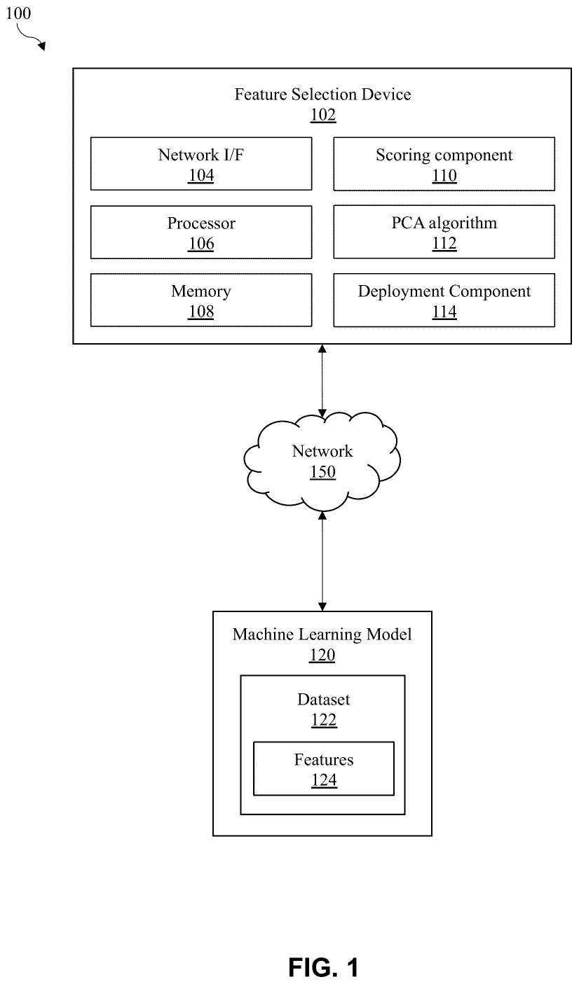

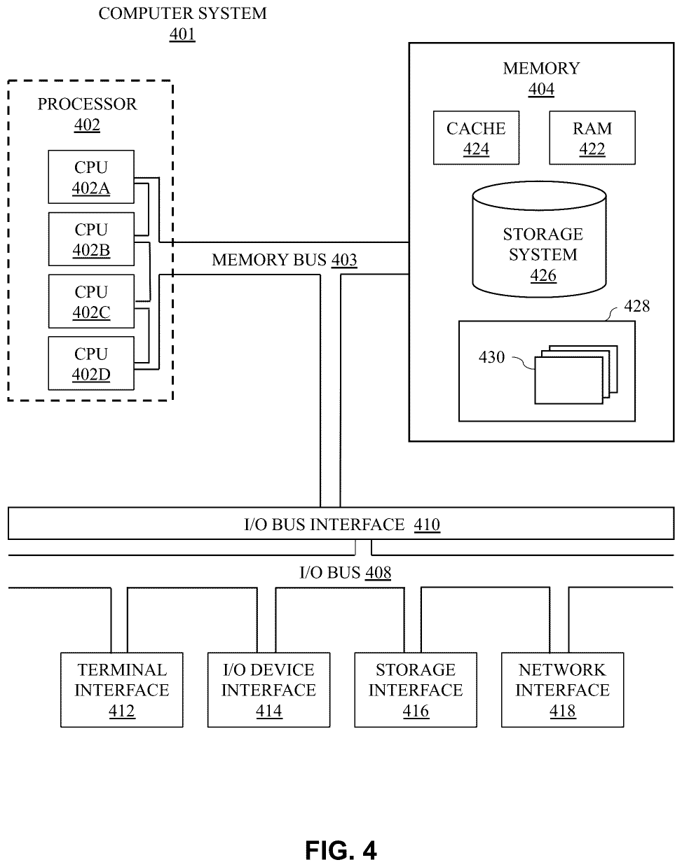

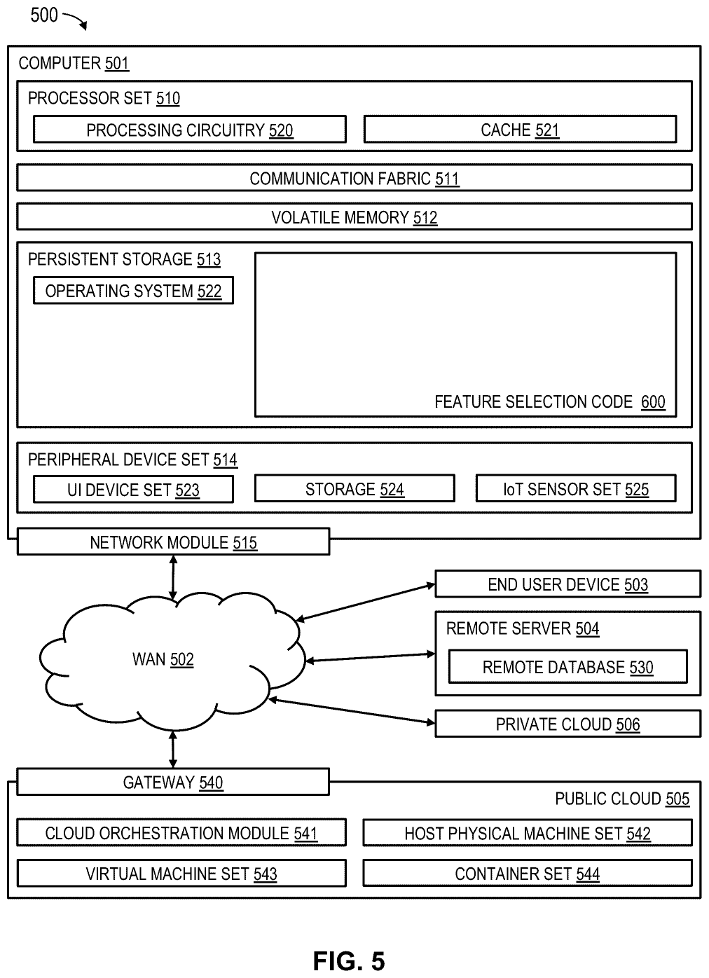

With reference now to FIG. 1, shown is a block diagram of an example automated machine learning system 100, in accordance with embodiments of the present disclosure. In the illustrated embodiment, automated machine learning system 100 includes feature selection device 102 that is communicatively coupled to machine learning model 120 via network 150. Feature selection device 102 may be configured as any type of computer system and may be substantially similar to computer system 401 detailed in FIG. 4. Machine learning model 120 may be configured as and/or reside on any type of computer system/network and include components similar to computer system 401 and/or 500 as described in FIG. 4 and FIG. 5, respectively. In embodiments, machine learning model 120 may be any type of computer system configured to perform machine learning model algorithms/processes, e.g., a neural network residing on a supercomputer comprising multiple nodes, where each nodes includes multiple GPUs, multiple drives, etc. Machine learning model 120 may include various components, processors, networks, etc., but for brevity, these components are not included in the figure.

Network 150 may be any type of communication network, such as a wireless network or a cloud computing network. Network 150 may be substantially similar to, or the same as, a computing environment 500 described in FIG. 5. In some embodiments, network 150 can be implemented within a cloud computing environment or using one or more cloud computing services. Consistent with various embodiments, a cloud computing environment may include a network-based, distributed data processing system that provides one or more cloud computing services, where machine learning model algorithms, processes, and/or training may be executed. Further, a cloud computing environment may include many computers (e.g., hundreds or thousands of computers or more) disposed within one or more data centers and configured to share resources over network 150. In some embodiments, network 150 can be implemented using any number of any suitable communications media.

In embodiments, machine learning model 120 includes dataset 122. In some embodiments, dataset 122 may be a structured dataset or a tabular representation that contains features 124 (also known as variables, attributes, or columns) which serve as inputs for machine learning model 120. For example, dataset 122 may be a feature table that is organized with rows representing individual instances or samples in the dataset and columns representing the various features 124 or attributes associated with each instance. Each column of the feature table may represent a specific characteristic, property, or measurement associated with the dataset. These features can be numerical, categorical, text, or other types of data. In embodiments, dataset 122 may comprise multiple datasets (first dataset, second dataset, n dataset, etc.) used for training the machine learning model. In embodiments, various datasets may be generated by manipulating dataset 122. For example, dataset 124 may be a whole dataset that is reduced by feature selection device 102. In embodiments, the reduced dataset may be merged with a transformed dataset that comprises new features that were generated from insignificant features by principal component analysis (PCA) algorithm 112.

In embodiments, dataset 122 serves as the primary input to machine learning model 120, where features 124 are used by the model to learn patterns, make predictions, or classify instances based on the relationships within the data. For instance, in a dataset for predicting whether an email is spam or not, the feature table might contain columns such as ‘word frequency’, ‘presence of certain keywords’, ‘email length’, etc., with each row representing an individual email. In a dataset predicting house prices, features like ‘number of bedrooms’, ‘square footage’, ‘location’, ‘year built’, etc., would be organized in a feature table, where each row represents a different house. The quality and relevance of the features in the dataset significantly impact the performance of machine learning models. Dataset 122 and/or feature 124 need to be well-structured, informative, and contain the right set of features to enable the model to learn patterns and make accurate predictions or classifications. As would be recognized by one of ordinary skill in the art, other features may be included depending on the type of machine learning model, and the examples given herein should not be construed as limiting. In some embodiments, machine learning model 120 may include some or similar components (e.g., processor, memory, algorithms, etc.) as feature selection device 102, but for brevity purposes these components are not shown.

In the illustrated embodiment, feature selection device 102 includes network interface (I/F) 104, processor 106, memory 108, scoring component 110, PCA algorithm 112, and deployment component 114.

In embodiments, scoring component 110 is configured analyze dataset 122 and associated features 124 to determine a training value for the dataset used to training the machine learning model 120. In some embodiments, training value is based on a parameter associated with each dataset 124. In some embodiments, the parameter is a feature importance value. In some embodiments, the training value may be a cross-validation (CV) score or value for dataset 122. The CV score is based on a resampling technique used to assess how well the machine learning model 122 will generalize to new, unseen data. In embodiments, performance of cross-validation involves partitioning the dataset 122 into multiple subsets or folds. The machine learning model 120 is trained on a portion of the data and then validated on the remaining portions, repeatedly across different combinations of training and validation sets. The most common form of cross-validation is k-fold cross-validation. The final CV score is calculated by averaging the performance scores (such as accuracy, mean squared error, etc.) obtained in each fold. The CV score is configured as a measure of a model's performance derived from cross-validation. In this way, it helps in evaluating how well the model generalizes to unseen data.

In some embodiments, the scoring component 110 may utilize a random forest algorithm that estimates a significance of each feature. In some embodiments, scoring component 110 may analyze features 124 and generate a features importance ratio for each feature of the dataset 122.

In embodiments, feature selection device 102 may identifying the most relevant features and discard irrelevant or redundant ones based on feature importance values or scores when compared to a predetermined threshold. The feature selection device 102 may utilize scoring component 110 to analyze the features and determine a measure of importance of each feature. In some embodiments, the score may be generated based on how much information a feature contributes on its own to the machine learning model and/or the given feature's contribution to the machine learning model's predictive power.

In some embodiments, feature selection device 102 and/or scoring component 110 may utilize various scoring techniques to determine feature importance, such as Statistical Tests: Correlation, t-tests, ANOVA for significance testing of individual features; Model-Specific Techniques; Tree-Based Models: Gini impurity, information gain, or mean decrease in impurity for decision trees or ensemble models like Random Forest, and the like.

In some embodiments, scoring component 110 may estimate the significance of each feature using a Random Forest algorithm. Random Forest is an ensemble learning method that constructs multiple decision trees and combines their predictions to make a final prediction. For regression tasks, the predictions from individual trees are averaged to obtain the final prediction. For classification tasks, the final prediction is made through a voting mechanism among the trees. Random Forests can provide insights into feature importance, helping to identify which features contribute most to the model's predictions.

In embodiments, principal component analysis (PCA) algorithm 112 is configured to analyze dropped and/or insignificant features that were removed from dataset 122 and generate new features from the dropped or insignificant features, wherein a transformed dataset may be generated using the new features. PCA algorithm 112 is configured to perform dimensionality reduction, feature extraction, and data visualization. Its primary goal is to transform high-dimensional data into a new coordinate system, reducing the number of variables while preserving the most important information. In this way, the PCA algorithm 112 aims to reduce the dimensionality by identifying a smaller set of variables, called principal components, that capture the maximum possible variance in the data. Principal components are new variables created as linear combinations of the original variables, ensuring that they capture the maximum variance. These components are orthogonal to each other, meaning they are uncorrelated. In embodiments, PCA algorithm 112 is configured to sort the components in descending order of the variance they capture, with the first component holding the most variance and subsequent components capturing less. The cumulative variance explained by the components can help determine how many components to retain for a trade-off between dimensionality reduction and information loss.

In embodiments, the feature selection device 102 may merge the transformed dataset with a reduced dataset to create a new dataset. The scoring component 110 may generated a training value (e.g., CV score/value) for the new dataset and compare it to previous training values for the whole dataset and/or reduced dataset.

In embodiments, deployment component 114 is configured to deploy or transmit the generated and/or determined datasets with better/higher training values (CV value/score) to a next stage in the machine learning model training pipeline.

In some embodiments, the feature selection device 102 may use machine learning to continuously run rounds of experiments to generate additional useful training data. For example, when a new set of inputs (such as new data inputs collected/received after implementing the optimized training solutions on the current state of the system 100) are presented to the machine learning model, it may prescribe training types based on the past actions for similar inputs. As the training data expands, the machine learning model is periodically retrained and/or refactored, resulting in increasingly accurate predictions of valid configuration parameter values that are likely to affect performance metrics of the machine learning model 120 based on predicted changes in computing resources. The results from prior experimentation are used to determine configuration and/or workload attribute variations and/or training type selections from which to gather data for future experiments. For example, using machine learning may identify one or more experimental values for one or more configuration parameters based on determining that historical changes to the one or more configuration parameters had an impact on one or more performance metrics that is over a threshold amount of change. For example, the machine learning model may identify historical changes for cross-validation parameters based on given training selection and optimize such parameters over time.

In machine learning, dimensionality refers to the number of features or variables present in a dataset. It describes the “dimension” of the dataset, where each feature represents an axis or direction within the data space. Features are individual properties, attributes, or columns within a dataset. These features contribute to the dimensions of the dataset.

The feature space represents a geometric space in which each feature corresponds to a dimension. For instance, in a 2D space, two features create a two-dimensional space. Datasets with a large number of features create high-dimensional data. This often occurs in real-world applications such as genomics, text analysis, or image processing, where the number of features can be substantial.

High-dimensional data can suffer from the curse of dimensionality, where models can struggle due to increased computational complexity, increased risk of overfitting, and the requirement of more data to generalize effectively. Dimensionality reduction techniques such as feature selection and feature extraction are used to reduce the number of features while retaining relevant information. This can improve model performance and reduce computational load.

In order to address high-dimensionality, embodiments of the present disclosure utilize feature selection techniques to identify and utilize the most relevant features for the training the machine learning model while discarding irrelevant or redundant ones. Further, embodiment of the present disclosure may perform various features extraction techniques such as Principal Component Analysis (PCA) or Linear Discriminant Analysis (LDA) transform the original features into a lower-dimensional space by creating new, more informative features. Dimensionality reduction should balance retaining essential information while reducing computational demands.

A machine learning model is trained using a particular machine learning algorithm. Once trained, input is applied to the machine learning model to make a prediction, which may also be referred to herein as a predicated output or output. A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process, such as feature selection device 102, executing a machine learning algorithm applies the model artifact against the input to generate a predicted output. A computer system process executes a machine learning algorithm by executing software configured to cause execution of the algorithm.

In some embodiments, feature synthesis may be performed. Feature synthesis is the process of transforming raw input into features that may be used as input to a machine learning model. Feature synthesis may also transform other features into input features. Feature engineering refers to the process of identifying features. A goal of feature engineering is to identify a feature set with higher feature predicative quality for a machine learning algorithm or model. Features with higher predicative quality cause machine learning algorithms and models to yield more accurate predictions. In addition, a feature set with high predicative quality tends to be smaller and require less memory and storage to store. A feature set with higher predicative quality also enables generation of machine learning models that have less complexity and smaller artifacts, thereby reducing training time and execution time when executing a machine learning model. Smaller artifacts also require less memory and/or storage to store.

FIG. 1 is intended to depict the representative major components of automated machine learning system 100. In some embodiments, however, individual components may have greater or lesser complexity than as represented in FIG. 1, components other than or in addition to those shown in FIG. 1 may be present, and the number, type, and configuration of such components may vary. Likewise, one or more components shown with automated machine learning system 100 may not be present, and the arrangement of components may vary. For example, while FIG. 1 illustrates an example automated machine learning system 100 having a single feature selection device 102 and a single machine learning model 120 that are communicatively coupled via a single network 150, suitable network architectures for implementing embodiments of this disclosure may include any number of feature selection devices, machine learning models, and networks. The various models, modules, systems, and components illustrated in FIG. 1 may exist, if at all, across a plurality of feature selection devices, machine learning models, and networks.

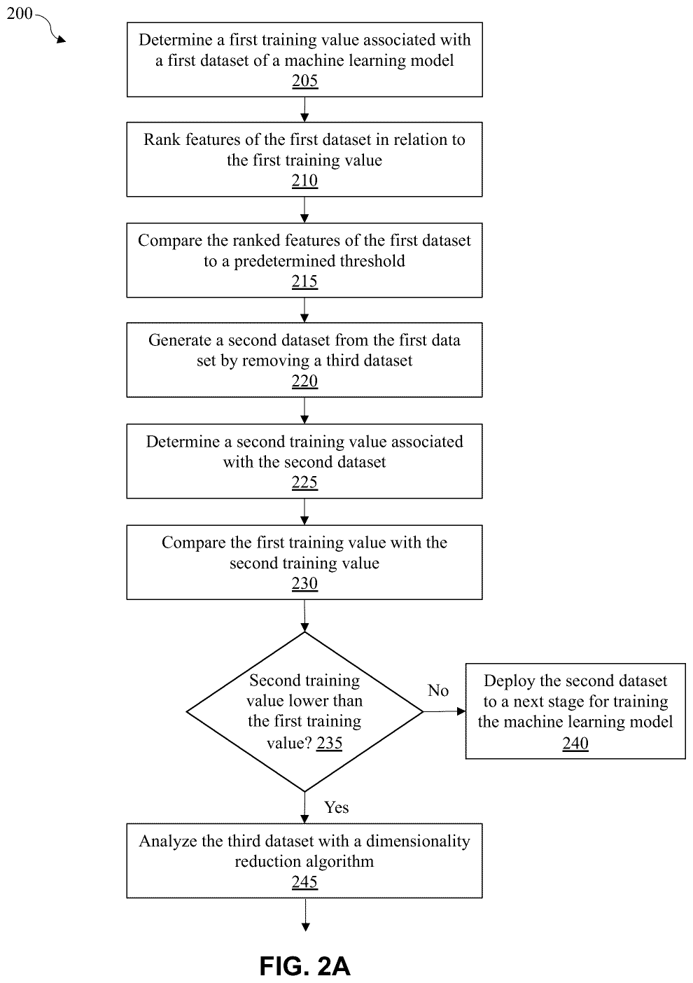

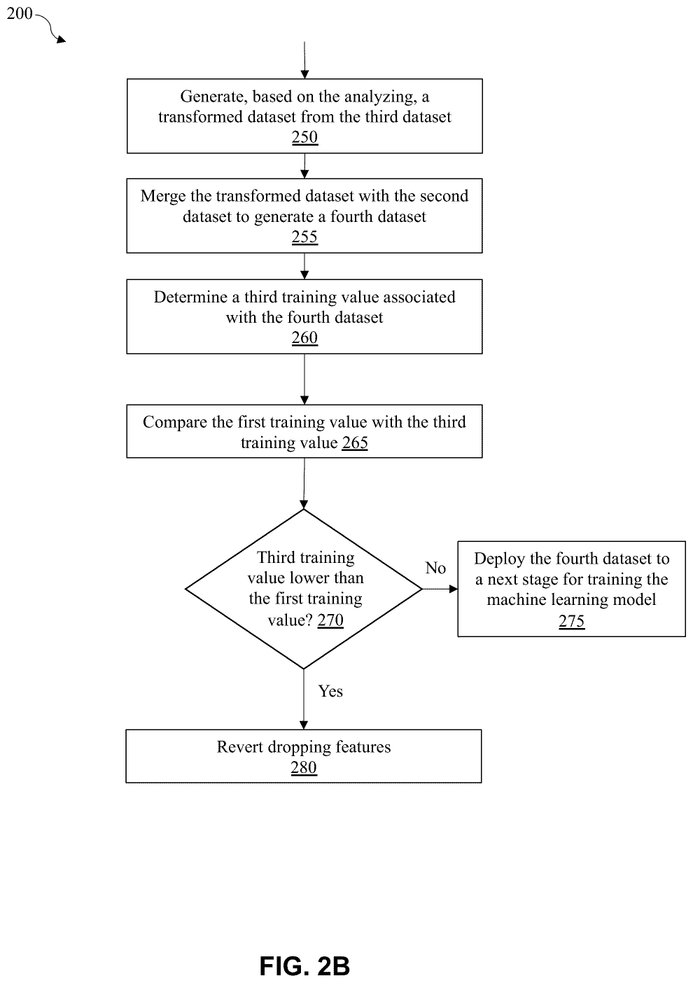

Referring now to FIG. 2A and FIG. 2B, shown is an example process 200 for automated feature dimensionality reduction for machine learning model training, in accordance with some embodiments of the present disclosure. The process 200 may be performed by processing logic that comprises hardware (e.g., circuitry, dedicated logic, programmable logic, microcode, etc.), software (e.g., instructions run on a processor), firmware, or a combination thereof. In some embodiments, the process 200 is a computer-implemented process. In embodiments, the process 200 may be performed by processor 106 of feature selection device 102 exemplified in FIG. 1.

The process 200 begins by determining a first training value associated with a first dataset of a machine learning model. This is illustrated at step 205 as shown in FIG. 2A. In embodiments, each training value (e.g., first, second, third training value, etc.) is based on a parameter associated with each dataset (e.g., first, second, third datasets, etc.). In some embodiments, the parameter is configured as a feature importance value. For example, the training score may be configured as a cross-validation (CV) score, wherein the CV score is computed on the whole dataset and a feature importance of each column.

The process 200 continues by ranking features of the first dataset in relation to the first training value. This is illustrated at step 210. For example, to detect whether a feature of the given dataset is significant or insignificant, the feature selection device 102 will determine a feature importance score for each column in a given dataset. In some embodiments, the ranking may be based on a computed feature importance ratio for each feature. In some embodiments, the ranking is performed by a random forest algorithm that estimates a significance of each feature.

The process 200 continues by comparing the ranked features of the first dataset to a predetermined threshold. This is illustrated at step 215. For example, the feature selection device 102 will only select features that are valuable for improving performance of the machine learning model. This may be performed by comparing scores of the ranked features to a predetermined threshold. For example, only features with significance higher than 0 will be selected. In this way, only features that are valuable for the machine learning model will be selected in order to save resources in next stages of the machine learning model training pipeline.

The process 200 continues by generating a second dataset from the first dataset by removing a third dataset, the third dataset comprising a set of features that did not meet the predetermined threshold. This is illustrated at step 220. For example, features that do not meet the predetermined threshold (insignificant features/third dataset) will be removed from the first dataset to create a reduced dataset (i.e., the second dataset).

The process 200 continues by determining a second training value associated with the second dataset of the machine learning model. This is illustrated at step 225. For example, using the reduced dataset (e.g., the second dataset), the machine learning model may be trained, and a second training score may be determined for the reduced dataset.

The process 200 continues by comparing the first training value associated with the first dataset to the second training value associated with the second dataset of the machine learning model. This is illustrated at step 230. In embodiments, the first training score and the second training score are compared to see if performance/accuracy of the machine learning model drops when using the reduced dataset. In this way, if feature importance is only estimated (e.g., random forest used to estimate feature importance), it may not reflect the real significance for the model.

In response to the second training value being higher than the first training value (“No” at step 235), the process 200 continues by deploying the second dataset to a next stage of the machine learning pipeline for training the machine learning model. This is illustrated at step 240. For example, because the second dataset (reduced dataset) has a higher training value than the whole dataset, the second dataset may be used in the next stage of the machine learning pipeline.

A machine learning pipeline refers to the sequence of steps or stages involved in developing and deploying a machine learning model. Each stage of the pipeline performs specific tasks, such as data preprocessing, feature engineering, model training, evaluation, and deployment. The pipeline stages are often iterative, involving revisiting and refining previous steps based on insights gained during the process. The pipeline stages can vary based on the problem domain, dataset characteristics, and specific requirements of the project. A well-structured machine learning pipeline facilitates the development of robust and effective models by systematically addressing data-related challenges, optimizing model performance, and ensuring successful deployment in real-world applications.

In response to the second training value being lower than the first training value (“Yes” at step 235), the process 200 continues by analyzing the third dataset with a dimensionality reduction algorithm. This is illustrated at step 245. For example, when the training score is worse using the reduced dataset rather than the whole dataset, the dropped columns (e.g., the third dataset) are analyzed using dimensionality reduction algorithm. In embodiments, the dimensionality reduction algorithm may be a principal analysis component algorithm.

In embodiments, the process 200 continues by generating, based on the analyzing, a transformed dataset from the third dataset, wherein the transformed dataset comprises one or more significant features that were generated from the set of features that did not meet the predetermined threshold. This is illustrated at step 250.

The process 200 continues by merging the transformed dataset with the second dataset to generate a fourth dataset. This is illustrated at step 255. For example, using the components obtained from the PCA, the insignificant columns/features are transformed and merged with significant columns/features of the second dataset, to create a new dataset (i.e., the fourth dataset).

The process 200 continues by determining a third training value associated with the fourth dataset of the machine learning model. This is illustrated at step 260. For example, a new CV value is computed for the fourth dataset to see if the score is higher than the first CV value of the whole dataset (first dataset).

The process 200 continues by comparing the first training value associated with the first dataset to the third training value associated with the fourth dataset. This is illustrated at step 265.

In response to the third training value being higher than the first training value (“No” at step 270), the process 200 continues by deploying the fourth dataset to a next stage of the machine learning pipeline for training the machine learning model. This is illustrated at step 275. In this way, the fourth dataset that has no loss in accuracy as a result of dimensionality reduction when compared to the first dataset is deployed/passed on through the next stages of the machine learning pipeline.

In response to the third training value being lower than the first training value (“Yes” at step 270), the process 200 continues by reverting dropping the features. This is illustrated at step 280. In some embodiments, the process 200 may continue by deploying the first dataset to the next stage of the machine learning pipeline. In this way, since the reduced datasets (the second dataset and fourth dataset) had exhibited accuracy loss since their CV values were less than the first training value, the feature selection device 102 automatically moves the first dataset to the next stage of training.

An example implementation of the process steps is included below:

The adaptive based algorithm to select significant features.

Example of feature importance vector:

feature importance=[1, 0.1, 0, 0.4, 0.5, 0, 0.8, 0]

In embodiments, the feature selection device 102 will choose columns at indices [0, 1, 3, 4, 6]. In this case the system chose Logistic Regression algorithm for classification so feature importance vector was computed using Random Forest algorithm.

Using those columns, a Logistic Regression estimator is trained, and the score is computed. In this example, the cross-validation score or value was 0.9 but now it drops to 0.895 because feature importance from Random Forest does not reflect the real value for each feature for Logistic Regression, which is not wanted.

As the lesser score is not acceptable, features at indices [2, 5, 7] are analyzed based on the Principal Component Analysis.

The principal components are used to transform rejected features in lesser number of features depending on number of chosen components. The new features are merged with columns chosen by feature selection device 102. If the CV value/score boosts or if it is the same as before feature selection, then new dataset is accepted and passed to the next stages.

It is noted that in the context of machine learning, indices refer to the position or location of specific features or columns within a dataset. Indices are numerical identifiers that denote the position of a feature or column within a table, matrix, or array structure, allowing access to specific elements within the dataset. Indices are often used to identify and select specific features or columns from a dataset. For example, in feature selection techniques, you might refer to columns by their index to include or exclude them from the model training process. Indices are instrumental in data manipulation tasks. For instance, you can use indices to extract, filter, or transform specific columns or features within a dataset. Indices allow for easy and direct access to particular columns or features within the dataset, facilitating manipulations, transformations, or model training with selected attributes.

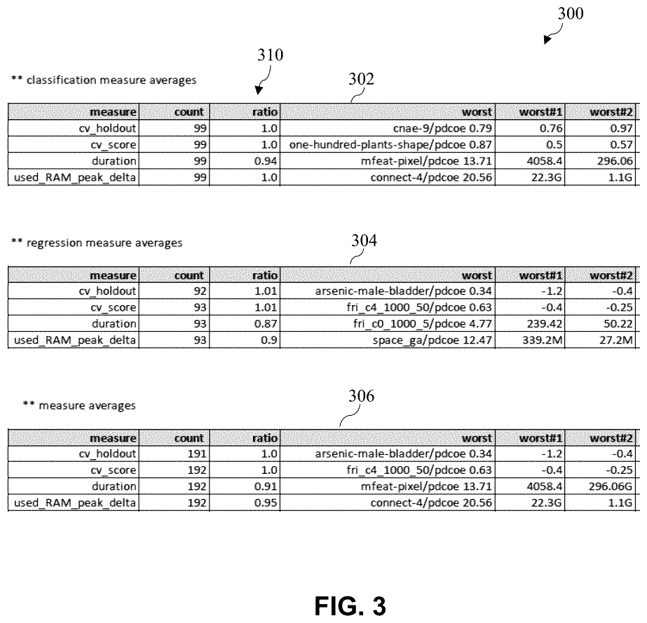

Referring now to FIG. 3, shown is an example results comparison 300, in accordance with embodiments of the present disclosure. The results comparison includes a classification measure averages table 302, a regression measure averages table 304, and a measure averages tables 306. The classification measure averages table 302 and the regression measure averages table 304 show a results comparison of the next two benchmark runs. The “ratio” column 310 in this case shows the ratio between results of the run with two stages implemented and the run without any feature selector. As shown, adding insignificant features transformed with the PCA can boost the CV score (going from 1.0 to 1.01) because when using an estimator that does not have feature importance attribute, features whose are insignificant to Random Forest estimator can be valuable to the estimator used in the system.

The main significance is using the “discarded” data for analysis by the Principal Component Analysis (PCA) algorithm. The main advantage of this is that this data can be used to improve model scores and overall performance. The discarded data is transformed by the PCA algorithm and merged during Machine Learning process to improve model score or at least prevent the score decreasing, to do that we are comparing scores after each dimensionality reduction and if the score decreases the Principal Component Analysis algorithm is used to on previously discarded data to prevent that.

The significance of this features is crucial to make this automated process optimised regarding to reduction of the computation and resource consumption without any losses in model performance (accuracy score). The accuracy score comparison can be used for determining if each operation brings desired effect. First, the comparison can be used to determine if the dimensionality reduction of the auxiliary features is needed, and it means that we can perform it only when the accuracy score of the model trained using only important features is less that the accuracy score of the model trained using the initial data set. Second, the comparison can be used to determine if the accuracy score of the model trained using the data set created by merging the important features with the features created by dimensionality reduction operation is greater than the accuracy score of the model trained using the whole initial data set to decide if the final model in the machine learning system should be trained using the initial data set or another one.

Improving the cross-validation (CV) score of a machine learning model is a key objective to enhance its predictive power and generalizability. Here are a few scenarios where changes or interventions result in an improved cross-validation score:

Consider a scenario where the initial model's CV score is moderate. After analyzing the data and incorporating additional relevant features derived from domain knowledge, the CV score improves. For instance, including interaction terms or creating new features could significantly enhance model performance.

A model with a high-dimensional dataset might suffer from noise or redundant features, causing overfitting. By performing feature selection to exclude irrelevant or highly correlated features, the model can yield a higher CV score due to reduced variance and improved generalization.

Using techniques like grid search or random search to fine-tune hyperparameters of the model, such as adjusting the learning rate in gradient boosting, depth of decision trees in a Random Forest, or the number of iterations in an SVM, might lead to a better CV score by optimizing the model's behavior and preventing overfitting.

Sometimes, switching to a more suitable model architecture or type might significantly improve the CV score. For example, transitioning from a simple linear model to a more complex ensemble method, like Random Forest or Gradient Boosting, could provide a substantial performance boost.

In specific domains, unique interventions, domain-specific feature engineering, or data preprocessing strategies can significantly improve the model's CV score. For instance, in natural language processing, using advanced tokenization techniques or embedding strategies might improve the model's performance.

Improving the CV score often involves a combination of thoughtful data preprocessing, feature engineering, hyperparameter tuning, and model selection strategies, aiming to build more accurate and robust machine learning models.

Referring now to FIG. 4, shown is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache. In some embodiments, a processor can include at least one or more of, a memory controller, and/or storage controller. In some embodiments, the CPU can execute the processes included herein (e.g., process 200 as described in FIG. 2A and FIG. 2B, respectively). In some embodiments, the computer system 401 may be configured as automated machine learning system 100 of FIG. 1.

System memory subsystem 404 may include computer system readable media in the form of volatile memory, such as random-access memory (RAM) 422 or cache memory 424. Computer system 401 may further include other removable/non-removable, volatile/non-volatile computer system data storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 404 can include flash memory, e.g., a flash memory stick drive or a flash drive. Memory devices can be connected to memory bus 403 by one or more data media interfaces. The memory subsystem 404 may include at least one program product having a set (e.g., at least one) of program modules that are configured to carry out the functions of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single units, the computer system 401 may, in some embodiments, contain multiple I/O bus interfaces 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface but receives requests from other computer systems (clients). Further, in some embodiments, the computer system 401 may be implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

One or more programs/utilities 428, each having at least one set of program modules 430 may be stored in memory subsystem 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment.

Programs/utilities 428 and/or program modules 430 generally perform the functions or methodologies of various embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pitslands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

Embodiments of the present disclosure may be implemented together with virtually any type of computer, regardless of the platform is suitable for storing and/or executing program code. FIG. 5 shows, as an example, a computing environment 500 (e.g., cloud computing system) suitable for executing program code related to the methods disclosed herein and for feature selection and management of machine learning models. In some embodiments, the computing environment 500 may be the same as or an implementation of the computing environment of automated machine learning system 100.

Computing environment 500 contains an example of an environment for the execution of at least some of the computer code involved in performing the inventive methods, such as feature selection code 600. The feature selection code 600 may be a code-based implementation of the automated machine learning system 100. In addition to feature selection code 600, computing environment 500 includes, for example, a computer 501, a wide area network (WAN) 502, an end user device (EUD) 503, a remote server 504, a public cloud 505, and a private cloud 506. In this embodiment, the computer 501 includes a processor set 510 (including processing circuitry 520 and a cache 521), a communication fabric 511, a volatile memory 512, a persistent storage 513 (including operating a system 522 and the feature selection code 600, as identified above), a peripheral device set 514 (including a user interface (UI) device set 523, storage 524, and an Internet of Things (IoT) sensor set 525), and a network module 515. The remote server 504 includes a remote database 530. The public cloud 505 includes a gateway 540, a cloud orchestration module 541, a host physical machine set 542, a virtual machine set 543, and a container set 544.

The computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 530. As is well understood in the art of computer technology, and depending upon the technology, performance of a computer-implemented method may be distributed among multiple computers and/or between multiple locations. On the other hand, in this presentation of the computing environment 500, detailed discussion is focused on a single computer, specifically the computer 501, to keep the presentation as simple as possible. The computer 501 may be located in a cloud, even though it is not shown in a cloud in FIG. 5. On the other hand, the computer 501 is not required to be in a cloud except to any extent as may be affirmatively indicated.

The processor set 510 includes one, or more, computer processors of any type now known or to be developed in the future. The processing circuitry 520 may be distributed over multiple packages, for example, multiple, coordinated integrated circuit chips. The processing circuitry 520 may implement multiple processor threads and/or multiple processor cores. The cache 521 is memory that is located in the processor chip package(s) and is typically used for data or code that should be available for rapid access by the threads or cores running on the processor set 510. Cache memories are typically organized into multiple levels depending upon relative proximity to the processing circuitry. Alternatively, some, or all, of the cache for the processor set may be located “off chip.” In some computing environments, the processor set 510 may be designed for working with qubits and performing quantum computing.

Computer readable program instructions are typically loaded onto the computer 501 to cause a series of operational steps to be performed by the processor set 510 of the computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 521 and the other storage media discussed below. The program instructions, and associated data, are accessed by the processor set 510 to control and direct performance of the inventive methods. In the computing environment 500, at least some of the instructions for performing the inventive methods may be stored in the feature selection code 600 in the persistent storage 513.

The communication fabric 511 is the signal conduction path that allows the various components of the computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 512 is any type of volatile memory now known or to be developed in the future. Examples include dynamic type random access memory (RAM) or static type RAM. Typically, the volatile memory 512 is characterized by random access, but this is not required unless affirmatively indicated. In the computer 501, the volatile memory 512 is located in a single package and is internal to the computer 501, but, alternatively or additionally, the volatile memory may be distributed over multiple packages and/or located externally with respect to the computer 501.

The persistent storage 513 is any form of non-volatile storage for computers that is now known or to be developed in the future. The non-volatility of this storage means that the stored data is maintained regardless of whether power is being supplied to the computer 501 and/or directly to the persistent storage 513. The persistent storage 513 may be a read only memory (ROM), but typically at least a portion of the persistent storage allows writing of data, deletion of data and re-writing of data. Some familiar forms of persistent storage include magnetic disks and solid-state storage devices. The operating system 522 may take several forms, such as various known proprietary operating systems or open-source Portable Operating System Interface-type operating systems that employ a kernel. The code included in the feature selection code 600 typically includes at least some of the computer code involved in performing the inventive methods.

The peripheral device set 514 includes the set of peripheral devices of the computer 501. Data communication connections between the peripheral devices and the other components of the computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 523 may include components such as a display screen, speaker, microphone, wearable devices (such as goggles and smart watches), keyboard, mouse, printer, touchpad, game controllers, and haptic devices. The storage 524 is external storage, such as an external hard drive, or insertable storage, such as an SD card. The storage 524 may be persistent and/or volatile. In some embodiments, the storage 524 may take the form of a quantum computing storage device for storing data in the form of qubits. In embodiments where the computer 501 is required to have a large amount of storage (for example, where the computer 501 locally stores and manages a large database) then this storage may be provided by peripheral storage devices designed for storing very large amounts of data, such as a storage area network (SAN) that is shared by multiple, geographically distributed computers. The IoT sensor set 525 is made up of sensors that can be used in Internet of Things applications. For example, one sensor may be a thermometer and another sensor may be a motion detector.

The network module 515 is the collection of computer software, hardware, and firmware that allows the computer 501 to communicate with other computers through the WAN 502. The network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 515 are performed on the same physical hardware device. In other embodiments (for example, embodiments that utilize software-defined networking (SDN)), the control functions and the forwarding functions of the network module 515 are performed on physically separate devices, such that the control functions manage several different network hardware devices. Computer readable program instructions for performing the inventive methods can typically be downloaded to the computer 501 from an external computer or external storage device through a network adapter card or network interface included in the network module 515.

The WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 503 is any computer system that is used and controlled by an end user (for example, a customer of an enterprise that operates the computer 501) and may take any of the forms discussed above in connection with the computer 501. The EUD 503 typically receives helpful and useful data from the operations of the computer 501. For example, in a hypothetical case where the computer 501 is designed to provide a recommendation to an end user, this recommendation would typically be communicated from the network module 515 of the computer 501 through the WAN 502 to the EUD 503. In this way, the EUD 503 can display, or otherwise present, the recommendation to an end user. In some embodiments, the EUD 503 may be a client device, such as thin client, heavy client, mainframe computer, desktop computer and so on.

The remote server 504 is any computer system that serves at least some data and/or functionality to the computer 501. The remote server 504 may be controlled and used by the same entity that operates computer 501. The remote server 504 represents the machine(s) that collect and store helpful and useful data for use by other computers, such as the computer 501. For example, in a hypothetical case where the computer 501 is designed and programmed to provide a recommendation based on historical data, then this historical data may be provided to the computer 501 from the remote database 530 of the remote server 504.

The public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 505 is performed by the computer hardware and/or software of the cloud orchestration module 541. The computing resources provided by the public cloud 505 are typically implemented by virtual computing environments that run on various computers making up the computers of the host physical machine set 542, which is the universe of physical computers in and/or available to the public cloud 505. The virtual computing environments (VCEs) typically take the form of virtual machines from the virtual machine set 543 and/or containers from the container set 544. It is understood that these VCEs may be stored as images and may be transferred among and between the various physical machine hosts, either as images or after instantiation of the VCE. The cloud orchestration module 541 manages the transfer and storage of images, deploys new instantiations of VCEs and manages active instantiations of VCE deployments. The gateway 540 is the collection of computer software, hardware, and firmware that allows the public cloud 505 to communicate through the WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 506 is similar to the public cloud 505, except that the computing resources are only available for use by a single enterprise. While the private cloud 506 is depicted as being in communication with the WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 505 and the private cloud 506 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. In some embodiments, one or more of the operating system 522 and the feature selection code 600 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining a first training value associated with a first dataset of a machine learning model;
ranking features of the first dataset in relation to the first training value;
comparing the ranked features of the first dataset to a predetermined threshold;
generating a second dataset from the first dataset by removing a third dataset, the third dataset comprising a set of features that did not meet the predetermined threshold;
determining a second training value associated with the second dataset of the machine learning model;
comparing the first training value associated with the first dataset to the second training value associated with the second dataset of the machine learning model; and
in response to the second training value being lower than the first training value, analyzing the third dataset with a dimensionality reduction algorithm.

2. The method of claim 1, further comprising:
generating, based on the analyzing, a transformed dataset from the third dataset, wherein the transformed dataset comprises one or more significant features that were generated from the set of features that did not meet the predetermined threshold.

3. The method of claim 2, further comprising:
merging the transformed dataset with the second dataset to generate a fourth dataset; and
determining a third training value associated with the fourth dataset of the machine learning model.

4. The method of claim 3, further comprising:
comparing the first training value associated with the first dataset to the third training value associated with the fourth dataset; and
in response to the third training value exceeding the first training value, deploying the fourth dataset to a next stage for training the machine learning model.

5. The method of claim 3, further comprising:
comparing the first training value associated with the first dataset to the third training value associated with the fourth dataset of the machine learning model; and
in response to the third training value being lower than the first training value, reverting to deployment of the first dataset to a next stage for training the machine learning model.

6. The method of claim 1, wherein each training value is based on a parameter associated with each dataset, and wherein the parameter is a feature importance value.

7. The method of claim 1, wherein the ranking is performed by a random forest algorithm that estimates a significance of each feature.

8. The method of claim 1, wherein the dimensionality reduction algorithm is a principal component analysis algorithm.

9. The method of claim 1, wherein each training score is a cross-validation score used to determine an estimated feature importance related to performance of the machine learning model.

10. A system comprising:
a processor; and
a computer-readable storage medium communicatively coupled to the processor and storing program instructions which, when executed by the processor, cause the processor to perform a method comprising:
determining a first training value associated with a first dataset of a machine learning model;
ranking features of the first dataset in relation to the first training value;
comparing the ranked features of the first dataset to a predetermined threshold;
generating a second dataset from the first dataset by removing a third dataset, the third dataset comprising a set of features that did not meet the predetermined threshold;
determining a second training value associated with the second dataset of the machine learning model;
comparing the first training value associated with the first dataset to the second training value associated with the second dataset of the machine learning model; and
in response to the second training value being lower than the first training value, analyzing the third dataset with a dimensionality reduction algorithm.

11. The system of claim 10, wherein the method performed by the processor further comprises:
generating, based on the analyzing, a transformed dataset from the third dataset, wherein the transformed dataset comprises one or more significant features that were generated from the set of features that did not meet the predetermined threshold.

12. The system of claim 11, wherein the method performed by the processor further comprises:
merging the transformed dataset with the second dataset to generate a fourth dataset; and
determining a third training value associated with the fourth dataset of the machine learning model.

13. The system of claim 12, wherein the method performed by the processor further comprises:
comparing the first training value associated with the first dataset to the third training value associated with the fourth dataset; and
in response to the third training value exceeding the first training value, deploying the fourth dataset to a next stage for training the machine learning model.

14. The system of claim 12, wherein the method performed by the processor further comprises:
comparing the first training value associated with the first dataset to the third training value associated with the fourth dataset of the machine learning model; and
in response to the third training value being lower than the first training value, reverting to deployment of the first dataset to a next stage for training the machine learning model.

15. The system of claim 10, wherein each training value is based on a parameter associated with each dataset, and wherein the parameter is a feature importance value.

16. A computer program product comprising a computer-readable storage medium having program instructions embodied therewith, the program instructions executable by a processor to cause the processor to perform a method comprising:
determining a first training value associated with a first dataset of a machine learning model;
ranking features of the first dataset in relation to the first training value;
comparing the ranked features of the first dataset to a predetermined threshold;
generating a second dataset from the first dataset by removing a third dataset, the third dataset comprising a set of features that did not meet the predetermined threshold;
determining a second training value associated with the second dataset of the machine learning model;
comparing the first training value associated with the first dataset to the second training value associated with the second dataset of the machine learning model; and
in response to the second training value being lower than the first training value, analyzing the third dataset with a dimensionality reduction algorithm.

17. The computer program product of claim 16, wherein the method performed by the processor further comprises:
generating, based on the analyzing, a transformed dataset from the third dataset, wherein the transformed dataset comprises one or more significant features that were generated from the set of features that did not meet the predetermined threshold.

18. The computer program product of claim 17, wherein the method performed by the processor further comprises:
merging the transformed dataset with the second dataset to generate a fourth dataset; and
determining a third training value associated with the fourth dataset of the machine learning model.

19. The computer program product of claim 18, wherein the method performed by the processor further comprises:
comparing the first training value associated with the first dataset to the third training value associated with the fourth dataset; and
in response to the third training value exceeding the first training value, deploying the fourth dataset to a next stage for training the machine learning model.

20. The computer program product of claim 18, wherein the method performed by the processor further comprises:
comparing the first training value associated with the first dataset to the third training value associated with the fourth dataset of the machine learning model; and
in response to the third training value being lower than the first training value, reverting to deployment of the first dataset to a next stage for training the machine learning model.
